(19) United States
(12) Patent Application Publication
(10) Pub. No.: US 2011/0222430 A1
(43) Pub. Date: Sep. 15, 2011

(54) METHOD AND DEVICE FOR ASSIGNING TRAFFIC TO A DIRECT TUNNEL, COMPUTER PROGRAM PRODUCT AND COMPUTER-READABLE MEDIUM

(75) Inventors: Jarmo Sakari Angervuori, Helsinkii (FI); Ravi Shankar Pandey, Masala (FI)

(73) Assignee: NOKIA SIEMENS NETWORKS OY, Espoo (FI)

(21) Appl. No.: 13/130,414

(22) PCT Filed: Nov. 20, 2008
(86) PCT No.: PCT/EP2008/065891

§ 371 Date: May 20, 2011

(51) Int. Cl. H04W 4/00; H04W 24/00

(52) U.S. Cl. 370/252; 370/329

(57) ABSTRACT

A method and a device assign traffic to a direct tunnel. The traffic is assigned to the direct tunnel based on a prioritization provided by a serving node and/or by a gateway node. In addition, a computer program product and computer-readable medium are provided.

The invention relates to a method and to a device for assigning traffic to a direct tunnel, to a computer program product and to a computer-readable medium.

Direct tunnels are specified by 3GPP TS 23.060 (General Packet Radio Service (GPRS); Service description). An SGSN implements this functionality to enable establishing a direct tunnel between a GGSN and a UTRAN in a UMTS network.

Direct Tunnel is an optional function in an Iu-mode that allows the SGSN to establish a direct user plane tunnel between an RAN and a GGSN within the PS domain.

A SGSN that is capable of processing direct tunnels shall have the capability to be configured on a per GGSN and a per RNC basis whether or not it can use a direct user plane connection.

The SGSN handles control plane signaling and provides a decision per PDP when to establish a direct tunnel. The current implementation of the direct tunnel mechanism is rather ineffective in its decision whether or not to establish a direct tunnel.

Assuming that only a certain number or percentage of direct tunnels are allowed or can be established (e.g., due to licensing restrictions), such lack of efficiency in assigning direct tunnels results in a poor utilization of hardware dedicated to Iu user plane handling.

For example, in a live network, operators may still be using SGSN user plane capacity. The SGSN implements a direct tunnel solution to avoid user plane traffic flowing through the SGSN user plane. Due to the huge amount of data traffic expected in the (near) future, a significant demand for additional user plane capacity will arise. Direct tunnel solutions are an important tool for an operator not having to purchase more SGSN capacity. Instead, the user plane can be bypassed and traffic can be conveyed directly from the GGSN to the RNC.

Data traffic increases incrementally, thus operators are inclined buying direct tunnel licenses stepwise.

The tunnel creation process is directly proportional to RAB assignment in SGSN. In live networks, the ratio between PDP context in view of RAB amounts to 5-10%, i.e. for every 100 PDP contexts in SGSN, there are 5 to 10 RABs. This figure is expected to increase to about 20-30% due to “Always-On” terminals and broadband type of access.

It can be observed that in a live network 20-30% of the subscribers use 60-70% of the user plane capacity, wherein the remaining 70-80% of the subscribers use 30-40% of user plane capacity. Disadvantageously, the present mechanisms are ineffective regarding any assignment of direct tunnels to particular types of users.

The 3GPP standard (TR 23.809) defines a mechanism to create, to update or to delete a direct tunnel. Also, it defines cases when direct tunnel shall not be created. As mentioned, there is no provision in the standard as how to effectively utilize direct tunnels with regard to existing or upcoming traffic.

The problem to be solved is to overcome the disadvantages mentioned above and in particular to provide an efficient utilization of direct tunnels.

This problem is solved according to the features of the independent claims. Further embodiments result from the depending claims.

In order to overcome this problem, a method is provided for assigning traffic to a direct tunnel, wherein said traffic is assigned to the direct tunnel based on a prioritization provided by a serving node and/or by a gateway node.

There may, in particular, be provided at least one serving node and/or at least one gateway node.

According to an embodiment, the serving node is a SGSN. According to a further embodiment, the gateway node is a GGSN.

It is noted that herein GGSN is mentioned as an example for a gateway node and SGSN is mentioned as an example for a serving node.

Said serving node and/or said gateway node may be any component of a network comprising a packet data switching function.

It is noted that such assignment may comprise re-assignment of traffic, in particular PDP traffic (that may be organized as PDP context in a PDP session).

The approach provided allows setting up, modifying, releasing at least one direct tunnel between a GGSN and a UTRAN (in particular a RNC) of a UMTS network. Such handling of the direct tunnel is provided in a prioritized way, i.e. certain features and information can be utilized in order to allow for an effective prioritization. Hence, a throughput via the direct tunnel can be increased (e.g., maximized) thereby minimizing a need for throughput provided via the usual two tunnel approach.

Advantageously, the solution presented provides a differentiation and/or priority mechanisms based on which it can be decided whether or not to establish a direct tunnel. Hence, direct tunnels can be crated (deleted, amended, etc.) in a selective manner to allow for an efficient utilization of user traffic in a way that, e.g., users' traffic with a high demand for bandwidth are conveyed through direct tunnel(s).

This approach proposes using parameters and maximizing the throughput of the direct tunnels, wherein a number of direct tunnels may be limited by a license control. Hence, a two tunnel user plane throughput requirement at the SGSN is reduced. Such an optimization results in an commercial and technical economization for the operator.

Advantageously, less SGSN capacity is required by the solution provided herein compared to the case handling two tunnels without prioritization.

In an embodiment, said direct tunnel is a tunnel between the gateway node and a UTRAN of a UMTS network.

In another embodiment, the prioritization provided comprises information regarding at least one RAB assigned to and/or created for a PDP context.

In a further embodiment, said prioritization is based on a user profile, in particular on a user profile per access point name (APN).

Hence, an user-specific information can be utilized for prioritization purposes.

In a next embodiment, said user profile is stored and/or associated with a database containing subscriber information.

Such database containing subscriber information may comprise, be part of or be associated with a HLR or a HSS (in case of IMS).

It is also an embodiment that the user profile comprises a direct tunnel preference.

Such direct tunnel preference may be, e.g., a tag or a flag, provided by or associated with the user's subscription or it may be based on an (pre-set or pre-defined) operator's preference.

Pursuant to another embodiment, the prioritization provided comprises a cell identification.

Hence, a local or regional information (e.g., home zone and/or office zone location) can be utilized by the decision whether or not to utilize a direct tunnel. Such cell identification (ID) can be received from a RNC during a PDP context creation procedure.

According to an embodiment, the prioritization provided is based on a terminal's capability or its identity.

For example, a terminal's identification such as an IMEI or an IMEISV could be used. The capability of the terminal may indicate the type of service that could be utilized by this device.

It is noted that terminal refers to any kind of mobile terminal or device that may comprise a mobile interface (e.g., computer, personal digital assistant, smartphone, mobile phone, user equipment (UE), etc.).

According to another embodiment, the prioritization provided is based on a load factor of at least a portion of the network.

The load factor may be assessed, e.g., by the SGSN and/or by the GGSN.

In yet another embodiment, the prioritization provided is based on a data volume, in particular on a data volume count of the serving node.

According to a next embodiment, the serving node prioritizes traffic that is conveyed via two tunnels based on the data volume.

Pursuant to yet an embodiment, highly prioritized two-tunnel traffic is assigned from the two tunnels to the direct tunnel.

The SGSN may in particular maintain a list sorted by the amount of traffic conveyed per PDP context via said two tunnels. In case a direct tunnel resource is available, the PDP context with the highest amount of traffic can be assigned from the two tunnels to the direct tunnel.

The event of a direct tunnel traffic being released can be indicated by a RAB inactivity timer.

This procedure may be applied iteratively, i.e. highly prioritized traffic conveyed via said two tunnels migrates to the direct tunnel in case a direct tunnel resource becomes available. This ensures that the direct tunnel(s) are utilized in an efficient way.

It is also an embodiment that the prioritization provided is based on a data volume and/or traffic analysis monitored and/or provided by the gateway node.

A data volume counter may be provided with the GGSN for all active PDP contexts. The GGSN may make a decision (based on the data volume and the direct tunnel indication supplied by the SGSN) to initiate an update PDP context procedure to switch two tunnel traffic into the direct tunnel.

According to another embodiment, said traffic is assigned to the direct tunnel in case a direct tunnel license is available.

The problem stated above is also solved by a device comprising a and/or being associated with a processor unit and/or a hard-wired circuit and/or a logic device that is arranged such that the method as described herein is executable thereon.

According to an embodiment, the device is a communication device, in particular a or being associated with a network component of a UMTS network, e.g., a SGSN or a GGSN.

The problem stated supra is further solved by a communication system comprising the device as described herein.

In addition, the problem described above is solved by a computer program product directly loadable into the internal memory of a digital computer, comprising software code portions for performing the steps according of the method as described herein when said product is run on the computer.

Furthermore, the problem indicated supra is also solved by a computer-readable medium having computer-executable instructions adapted to cause a computer system to perform steps of the method as described herein.

It is noted that such computer may be any device comprising and/or associated with at least one processor and/or at least one hard-wired circuit that is operable by said computer program product and/or by instructions stored on the computer-readable medium. Said program or instructions may be in particular used for updating purposes of a network component or node, in particular of a GGSN or a SGSN.

Embodiments of the invention are shown and illustrated in the following figures:

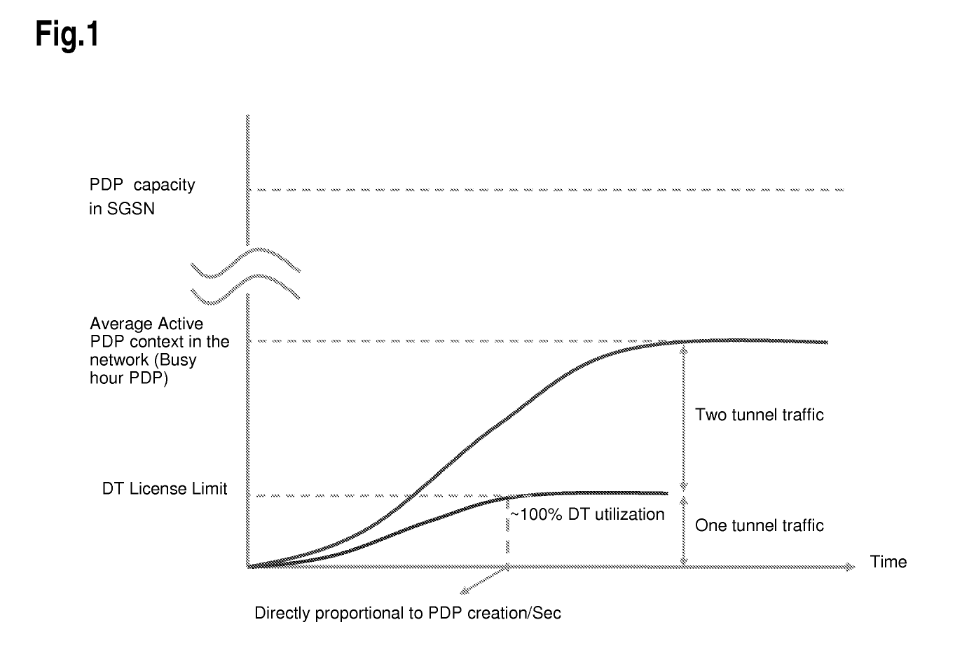

FIG. 1 shows a diagram visualizing PDP traffic over time utilizing one tunnel traffic and two tunnel traffic;

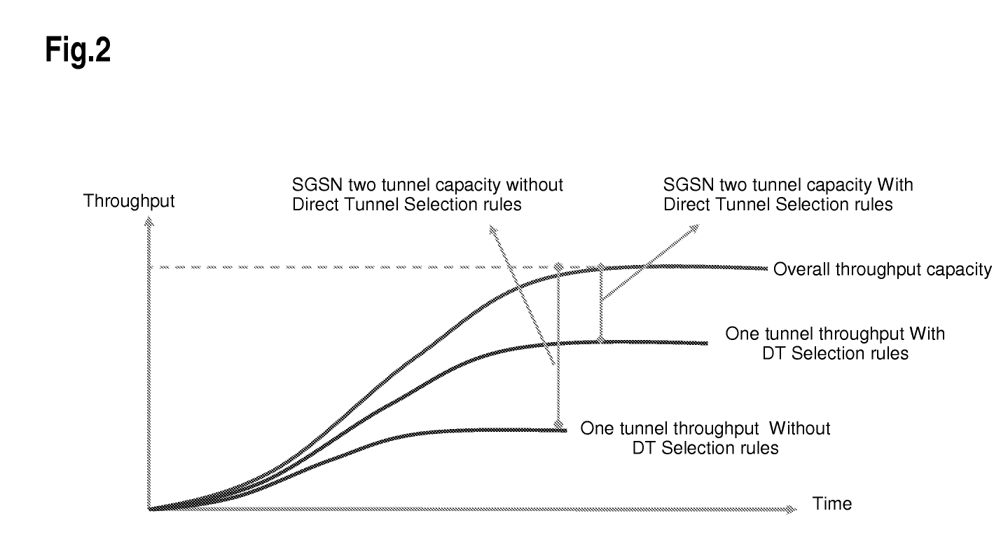

FIG. 2 shows a diagram visualizing throughput over time, wherein an efficient utilization of the direct tunnel allows to reduce throughput to be provided by the conventional two tunnel approach;

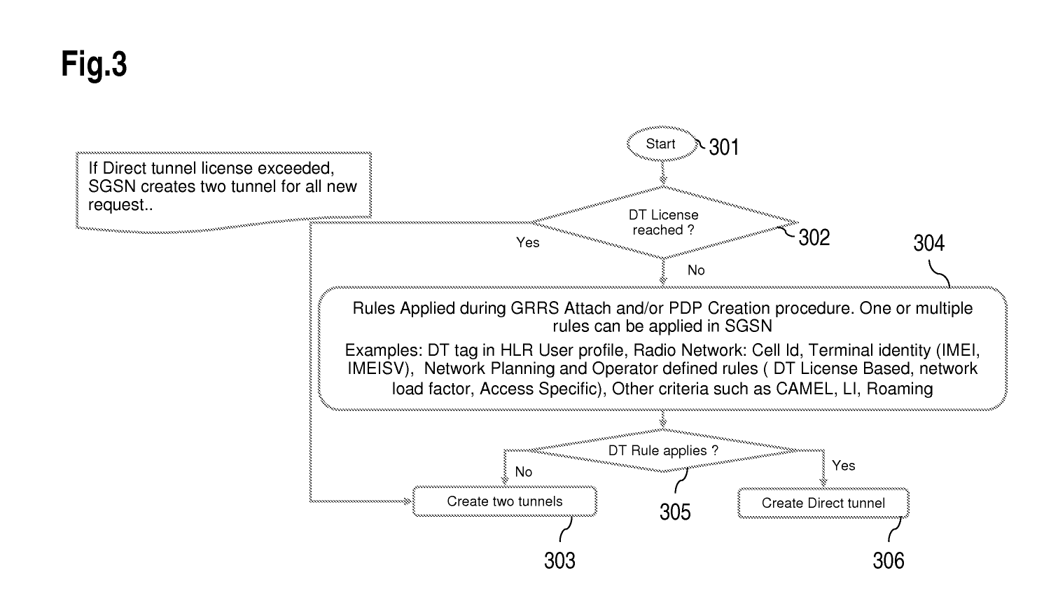

FIG. 3 shows a flow diagram comprising steps to decide whether to create two tunnels or a direct tunnel;

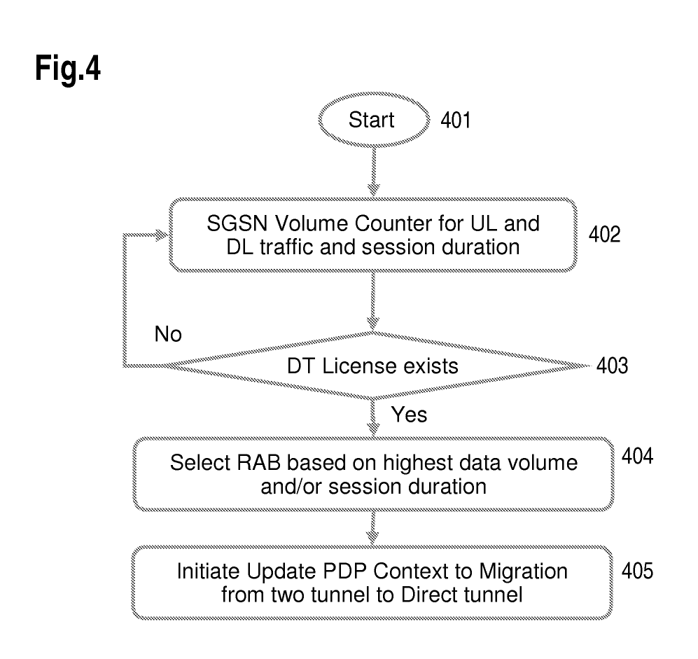

FIG. 4 shows a flow diagram visualizing the concept of a volume counter in order to determine whether migration to direct tunnels may proof useful;

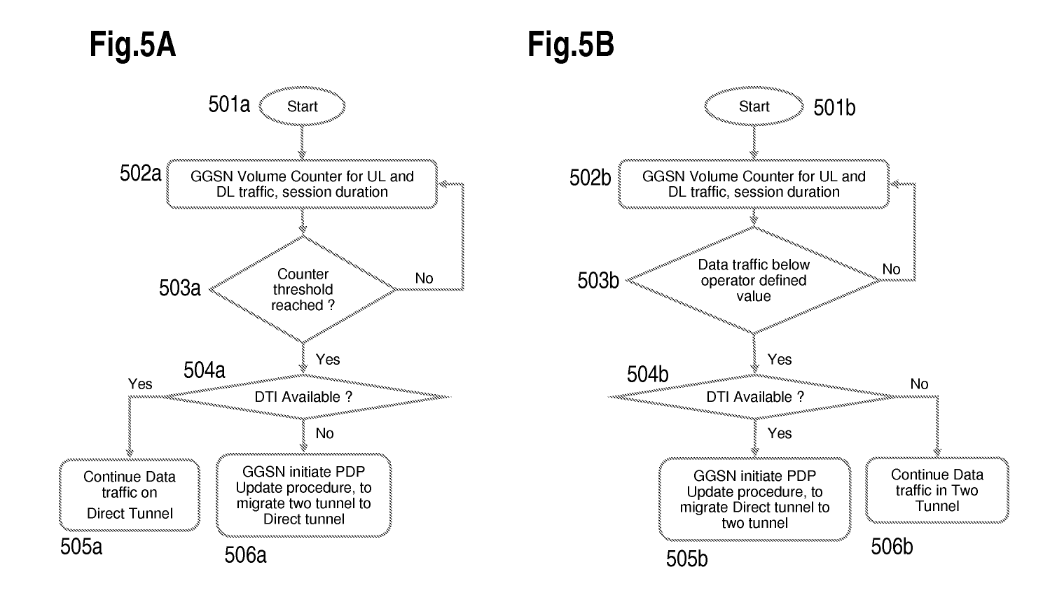

FIG. 5A shows a flow diagram comprising an example as how to migrate two tunnels to a direct tunnel based on a GGSN volume counter;

FIG. 5B shows an example as how to migrate a direct tunnel to two tunnels based on the GGSN volume counter;

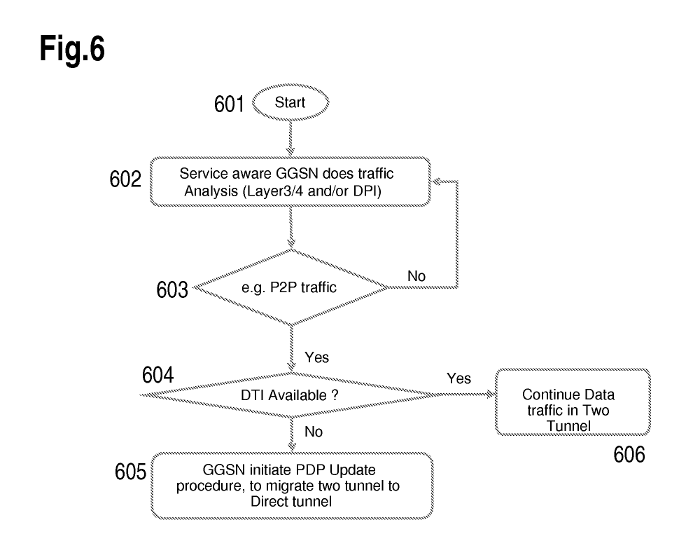

FIG. 6 shows a flow diagram comprising steps to decide whether to migrate PDP context to a direct tunnel based on a traffic analysis provided by the GGSN;

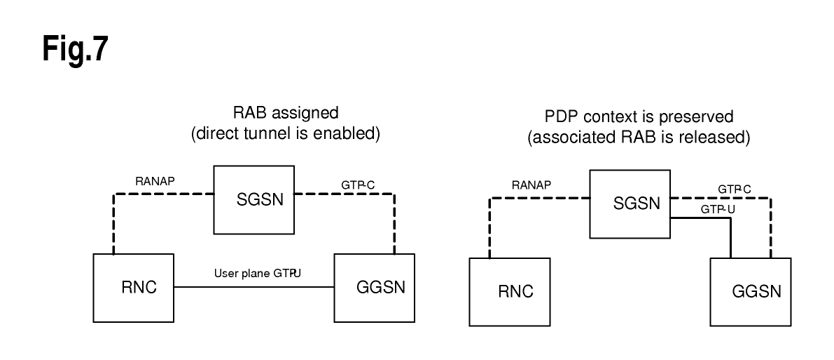

FIG. 7 shows an arrangement of components to compare a direct tunnel and two tunnel approach.

FIG. 1 illustrates a situation where a certain number of active PDPs (license restricted) are allowed to be carried via a direct tunnel (DT) and all remaining PDPs (exceeding the DT license limit) are conveyed conventionally via two tunnels. Regardless of the ratio between the number of two tunnels and direct tunnels, it is an objective of the approach provided herewith that high data volume is sent through the direct tunnels in order to minimize the need for two tunnel throughput.

The approach suggested herein provides in particular rules to determine whether or not to use a direct tunnel, in particular for certain portions of traffic (PDP context, RAB assignment).

In particular, an algorithm is provided that may be implemented in (or associated with) an SGSN in order to improve (e.g., maximize) a throughput capacity for the direct tunnels. Hence, the direct tunnels are exploited in a more efficient way thereby minimizing a throughput need for the remaining two tunnels as depicted in FIG. 2.

Keeping the same license limits for direct tunnels and applying the new direct tunnel selection rules as suggested and/or SGSN algorithms may result in
an increase of an average user planes throughput using at least one direct tunnel; and
a decrease for SGSN user plane capacity (that is required or reserved for two tunnels).

FIG. 7 shows an arrangement of components to compare a direct tunnel and two tunnel approach. For example, with RABs being assigned or re-assigned for a PDP context the SGSN may decide whether to enable direct user plane tunnel between an RNC and a GGSN or if it may handle user plane data via two tunnels. Further, whenever the RAB assigned for a PDP context is released (i.e. the PDP context is preserved) the GTP-U tunnel may be established between the GGSN and SGSN in order to be able to handle the downlink packets.

### SGSN Based Solution

### Rule Applied During New RAB Creation (Active PDP)

### a) HLR User Profile Based Rules:

A rule to select the direct tunnel rule in the SGSN can be based on a user profile per APN. Alternatively, the user profile may comprise an additional information element in the HLR profile to indicate a “direct tunnel preference” (either by subscription or based on an operator's preference).
   During a GRPS attach procedure, the SGSN receives the user profile from the HLR. The user profile per APN could be utilized to select the direct tunnel, i.e. during attach procedure, the SGSN becomes aware of subscribers that may utilize direct tunnel.
   As an alternative, the user profile may comprise an additional information element in the HLR profile to indicate a “direct tunnel preference”. E.g., a direct tunnel tag in the HLR could be provided for such purpose.

### b) Radio Network: Cell ID (Home & Office Location):

A cell ID information may be received from the RNC during a PDP context creation procedure. A home zone and/or an office zone location information may be used to define a rule to create (or select) a direct tunnel.
For example, a subscriber may have a flat rate for a broadband type of service for home as well as for office use. As an alternative, a subscriber using the services from home or from the office may have a minimum degree of mobility and a maximum degree of data usage. As a session duration for a static user is relatively high compared to a highly mobile user, the benefit of the direct tunnel could be applied to such static user.

### c) Terminal Identity (IMEI, IMEISV) Based Rule for Direct Tunnel Creation or Selection:

An information regarding a terminal's capability may be used for statistically predicting the nature of services of a particular subscriber associated with such terminal may use during a session. For example: In case a 3G PCMCIA card is used to access the data network this may allow predicting that such subscriber is inclined to require a high degree of data traffic and may hence advantageously be assigned to a direct tunnel.

### d) Network Planning and Operator Defined Rules:

Direct tunnel differentiation can be provided based on the GGSN in the packet core network. In the operator's network, at least one GGSN can be allocated for processing direct tunnels only. The operator may define operation and maintenance (O&M) rules for establishing direct tunnels based on a network load factor.

### Direct Tunnel Selection Algorithm for RABs Based on a Data Volume Count in the SGSN

Once the direct tunnel license has been exceeded, all further PDP traffic may be established via two tunnels. Hence, the SGSN may start prioritizing the PDP sessions using direct tunnels, in particular by considering at least one of the following aspects:
a) The SGSN may count a data volume in, e.g., a data volume priority list for all two tunnel PDP traffic and may keep track on the priority based on the highest volume count (i.e., the highest data volume two tunnel PDP traffic may always be on top of such list).
b) A direct tunnel PDP traffic can be released based on a RAB inactivity timer and will be (immediately) replaced by the highest priority (i.e. highest data volume) two tunnel PDP traffic identified by said data volume priority list updated and/or maintained by the SGSN.
c) In particular, those two tunnel PDP traffic fulfilling the direct tunnel creation rule(s) may be used from the volume priority list to be conveyed via direct tunnel.
d) This iteration may be processed (or repeated) as long as the limit for direct tunnel license is exceeded.

### GGSN Based Solution

### Data Volume in the GGSN:

The GGSN maintains a data volume counter for all active PDP contexts. The GGSN monitors the data volume (e.g., both in uplink and in downlink direction) per session. Furthermore, the GGSN may make the decision (based on the data volume and the direct tunnel indication supplied by the SGSN) to initiate an update PDP context procedure to switch two tunnel traffic into the direct tunnel.

### IMPLEMENTATION EXAMPLES

The SGSN may implement a direct tunnel selection logic based on at least one of the rules mentioned herein.

Procedure Used During Initial GRPS Attach and/or PDP Creation Procedure

FIG. 3 shows a flow diagram comprising steps to decide whether to create two tunnels or a direct tunnel. Next to a start 301, the SGSN checks in a step 302 whether a direct tunnel license is available. If there is no such license available, the SGSN creates two tunnels (step 303). Otherwise, at least one rule may be utilized for allocating one tunnel license. Hence, if the direct tunnel (DT) license limit is not reached, it is branched from step 302 to a step 304 applying and/or processing rules during GPRS attach and/or during PDP creation. At least one of such rules may be applicable.

For example, a direct tunnel tag in an HLR user profile or a cell ID or terminal identity (e.g., IMEI, IMEISV) of the radio network may be utilized. Further, rules defined by network planning and/or by the operator (DT license based, network load factor, access specifics) may be applicable as well. In addition, other criteria as CAMEL (Customized Application for Mobile Network Enhanced Logic), Lawful Interception (LI), roaming could be used as (part of) a rule.

In a step 305 pursuant to step 304 it is checked whether a direct tunnel rule applies and in the affirmative, a direct tunnel is created in a step 306. Otherwise, it is branched to step 303 and two tunnels are created.

It is noted that in case the direct tunnel license is exceeded, the SGSN may create two tunnels for all new requests.

The SGSN may maintain a volume counter table comprising uplink and downlink data volume and session duration for all RABs having two tunnels. Based on the availability of a direct tunnel, the RAB with the highest data volume and/or with the highest session duration is moved from two tunnels to the direct tunnel. This procedure may help assigning the most active RABs (by terms of data volume and/or session time) to direct tunnel(s).

FIG. 4 shows a flow diagram visualizing the concept of a volume counter in order to determine whether migration to direct tunnels may proof useful.

Pursuant to a start 401, in a step 402 the SGSN volume counter for uplink (UL) and downlink (DL) traffic as well as for session duration is processed and/or maintained. For such purpose, at least one counter for each criterion may be provided. In a step 403 it is checked whether a direct tunnel license exists, i.e. whether a direct tunnel is available. If not, it is branched to step 402. If a direct tunnel is available, a step 404 selects a RAB based on the highest data volume and/or based on a session duration, preferably by utilizing said counter(s) maintained in step 402. Next to step 404, a PDP context update is initiated to migrate two tunnels to a direct tunnel in a step 405.

### GGSN-Based Volume Counters

As an option, the GGSN may maintain a volume counter table comprising uplink and downlink data volume and/or session duration for all active PDP contexts. Since the GGSN is not aware of load factor in the SGSN as well as available direct tunnel licenses, a threshold value is defined for these counters.

A Direct Tunnel Indicator (DTI) defined in 3GPP may be used to evaluate if an allocated direct tunnel is sufficiently utilized or not.

Based on at least one predetermined threshold value in the GGSN, the GGSN may initiate
1) an update of the PDP context to move two tunnels to a direct tunnel for high volume traffic via the PDP;
2) an update of the PDP context to move direct tunnels to two tunnels for low volume traffic via the PDP.

FIG. 5A shows a flow diagram comprising an example as how to migrate two tunnels to a direct tunnel based on a GGSN volume counter and FIG. 5B shows an example as how to migrate a direct tunnel to two tunnels based on the GGSN volume counter.

With regard to FIG. 5A, after a start 501a, the GGSN volume counter for uplink (UL) and downlink (DL) traffic as well as for session duration is processed and/or maintained in a step 502a. In a step 503a it is checked whether a counter threshold is reached. If not, it is branched to step 502a. If the counter threshold is reached, it is checked in a step 504a whether a DTI is available. If no DTI is available, the GGSN initiates a PDP update procedure to migrate two tunnels to a direct tunnel (step 506a). If, however, such DTI is available in step 504a, it is branched to a step 505a and data traffic is continued to be conveyed via the direct tunnel.

With regard to FIG. 5B, after a start 501b, the GGSN volume counter for uplink (UL) and downlink (DL) traffic as well as for session duration is processed and/or maintained in a step 502b. In a step 503b it is checked whether the data traffic is below a threshold or value that may be predetermined or defined by an operator. If not, it is branched to step 502b. If the data traffic has reached said threshold or value, it is checked in a step 504b whether a DTI is available. If such DTI is available, the GGSN initiates a PDP update procedure to migrate a direct tunnel to two tunnels (step 505b). If, however, such DTI is not available in step 504b, it is branched to a step 506b and data traffic is continued to be conveyed via the two tunnels.

### Tunnel Creation & Deletion Rules can be Driven by GGSN Based on Traffic Analysis Rules

Traffic analysis in the GGSN can indicate a usage of a service type. Such traffic analysis that is based on the GGSN is not utilized by the SGSN. P2P/VoIP traffic session detection provided by the GGSN may help the SGSN to establish a direct tunnel, because an average session duration for such traffic is significantly longer than other traffic and it may also indicate a high(er) data volume.

During PDP context activation and/or modification procedure, the SGSN may send a DTI to the GGSN. The GGSN may utilize traffic analysis results to recommend (not) using the direct tunnel mechanism. An optional information element may be provided in GTP-C, which recommends not/using (=using or not using) the direct tunnel mechanism. As an alternative, the GGSN may initiate a “Network initiated PDP modification” based on L3/L4/L7 traffic optionally indicating the recommendation of not/using a direct tunnel.

FIG. 6 shows a flow diagram comprising steps to decide whether to migrate PDP context to a direct tunnel based on a traffic analysis provided by the GGSN.

After a start 601, in a step 602 the service-aware GGSN analyses the traffic. In a subsequent step 603 a type of traffic it checked, e.g., point-to-point traffic (P2P). If there is no such type of traffic it is branched to step 602. Otherwise, in a step 604, it is checked whether DTI is available. If this is not the case, the GGSN initiates a PDP update procedure to migrate two tunnels to a direct tunnel in a step 605. If no DTI is available in step 604, it is branched to a step 606 and data is continued to be conveyed via the two tunnels.

### LIST OF ABBREVIATIONS

APN Access Point Name
DPI Deep Packet Inspection
DT Direct Tunnel
DTI Direct Tunnel Indicator
GGSN Gateway GPRS Support Node
GTP GPRS Tunneling Protocol
GTP-C GTP Control Plane
GTP-U GTP User Plane
HLR Home Location Register
HSS Home Subscriber Server
IMEI International Mobile station Equipment Identity
IMEISV IMEI and Software Version number
IP Internet Protocol
IMS IP Multimedia Subsystem
Iu Interface between the RNS and the core network
L3/L4/L7 Layer 3/Layer 4/Layer 7
O&M Operation and Maintenance
P2P Peer-to-Peer
PDP Packet Data Protocol, e.g., IP
PS Packet Switched
RAB Radio Access Bearer
RAN Radio Access Network
RANAP RAN Application Part
RNC Radio Network Controller
RNS Radio Network Subsystem
SGSN Serving GPRS Support Node
UTRAN UMTS Terrestrial Radio Access Network
VoIP Voice over IP

1-19. (canceled)

20. A method for assigning traffic to a direct tunnel, the method which comprises:
assigning the traffic to the direct tunnel based on a prioritization provided by a serving node and/or by a gateway node.

21. The method according to claim 20, wherein the serving node is a SGSN.

22. The method according to claim 20, wherein the gateway node is a GGSN.

23. The method according to claim 20, wherein the direct tunnel is a tunnel between the gateway node and a UTRAN of a UMTS network.

24. The method according to claim 20, wherein the prioritization comprises information regarding at least one RAB assigned to and/or created for a PDP context.

25. The method according to claim 20, wherein the prioritization is based on a user profile

26. The method according to claim 25, wherein the prioritization is based on a user profile per access point name.

27. The method according to claim 25, wherein the user profile is stored and/or associated with a database containing subscriber information.

28. The method according to claim 25, wherein the user profile comprises a direct tunnel preference.

29. The method according to claim 20, wherein the prioritization comprises a cell identification.

30. The method according to claim 20, wherein the prioritization is based on a capability or identity of a terminal.

31. The method according to claim 20, wherein the prioritization is based on a load factor of at least a portion of the network.

32. The method according to claim 20, wherein the prioritization is based on a data volume.

33. The method according to claim 32, wherein the prioritization is based on a data volume count of or at the serving node.

34. The method according to claim 32, wherein the serving node is configured to prioritize traffic that is conveyed via two tunnels based on the data volume.

35. The method according to claim 34, wherein highly prioritized traffic is assigned from the two tunnels to the direct tunnel.

36. The method according to claim 20, wherein the prioritization is based on a data volume and/or traffic analysis monitored and/or provided by the gateway node.

37. The method according to claim 20, wherein the traffic is assigned to the direct tunnel if a direct tunnel license is available.

38. A device, comprising: at least one of a processor unit, a device associated with a processor unit, a hard-wired circuit, and/or a logic device configured and arranged to enable the method according to claim 20 to be executed thereon.

39. A computer program product directly loadable into the internal memory of a digital computer, comprising: software code portions configured to cause the computer to perform the steps according to claim 20 when the software code portions are executed on the computer.

40. A computer-readable medium, comprising computer-executable instructions in non-transitory form adapted to cause a computer system to perform the method according to claim 20.
